(19) United States
(12) Patent Application Publication
(10) Pub. No.: US 2024/0219857 A1
(43) Pub. Date: Jul. 4, 2024

(54) TONER

(71) Applicant: CANON KABUSHIKI KAISHA, Tokyo (JP)

(72) Inventors: TOMOHISA SANO, Shizuoka (JP); TOHRU HIRAMATSU, Shizuoka (JP); ATSUHIKO OHMORI, Kanagawa (JP); KOSUKE FUKUDOME, Tokyo (JP); HIROKI KAGAWA, Shizuoka (JP)

(21) Appl. No.: 18/396,571

(22) Filed: Dec. 26, 2023

(30) Foreign Application Priority Data
Dec. 27, 2022 (JP) 2022-209747
Nov. 28, 2023 (JP) 2023-200924

(51) Int. Cl. G03G 9/097; G03G 9/087

(52) U.S. Cl. CPC G03G 9/09775; G03G 9/08711; G03G 9/09708; G03G 9/09733

(57) ABSTRACT

A toner includes a toner particle containing a binder resin and an external additive. A fragment peak derived from a boron atom and a fragment peak derived from a boron-oxygen structure are detected by time-of-flight secondary ion mass spectrometry (TOF-SIMS) measurement of the toner. The toner particle contains dodecylbenzenesulfonic acid or a dodecylbenzenesulfonic acid salt. Hydrotalcite is contained as the external additive.

### BACKGROUND

### Field

The present disclosure relates to a toner used for an electrophotographic method, an electrostatic recording method, and a toner-jet-system recording method (hereafter also referred to simply as “toner”).

### Description of the Related Art

To enable a full-color image forming apparatus such as a full-color copier and a full-color printer to print a greater number of sheets than ever, higher endurance is desired, and in addition, maintenance of high image quality such as reproducibility of a fine dot is simultaneously desired.

In recent years, to realize excellent image quality, for example, Japanese Patent Laid-Open No. 2018-194837 proposed that chargeability of a toner is improved by disposing, on the surface, an external additive such as a hydrotalcite particle having either negative polarity or positive polarity.

In this regard, from the viewpoint of endurance, an approach to improving glossiness or fixability has also been taken. For example, Japanese Patent No. 6059251 proposes a toner by using borax coupling. However, the proposed technology has an insufficient effect of improving a charge rising property, and there is room for improvement.

### SUMMARY

The above-described hydrotalcite particle is charged having a polarity opposite to the polarity of a toner, tends to act as a carrier, and improves the chargeability of the toner, and an effect of improving the above-described fine dot reproducibility (hereafter referred to as “1 dot reproducibility”) is expected. To enhance the function as a carrier, it is necessary that the degree of freedom is high on the toner surface. On the other hand, when the hydrotalcite particle is disposed with high degree of freedom, a phenomenon of the hydrotalcite being condensed particularly during long-term use frequently occurs.

In particular, when condensation occurs in an environment such as low temperature and low humidity in which chargeability tends to be enhanced, since the chargeability becomes excessive, various adverse effects are exerted on an image such as 1 dot reproducibility. To prevent this phenomenon, enhancement of adhesiveness to the toner particle surface is considered. However, since the function as a carrier deteriorates, as described above, a merit of using the hydrotalcite is decreased.

Consequently, in a system in which a hydrotalcite particle is used, a toner capable of maintaining excellent 1 dot reproducibility during endurance has not been realized.

Accordingly, the present disclosure provides a toner that has excellent 1 dot reproducibility, that improves the chargeability, and that stably forms a high-quality electrophotographic image even when a lifetime is increased.

The present disclosure relates to a toner including a toner particle containing a binder resin and an external additive, wherein a fragment peak derived from a boron atom and a fragment peak derived from a boron-oxygen structure are detected by time-of-flight secondary ion mass spectrometry (TOF-SIMS) measurement of the toner, the toner particle contains dodecylbenzenesulfonic acid or a dodecylbenzenesulfonic acid salt, and hydrotalcite is contained as the external additive.

Further features of the present disclosure will become apparent from the following description of exemplary embodiments.

### DESCRIPTION OF THE EMBODIMENTS

In the present disclosure, descriptions such as “XX or more and YY or less” and “XX to YY” which express a numerical range are numerical ranges including a lower limit and an upper limit, which are end points, unless otherwise specified. In the instance in which numerical ranges are described in a stepwise manner, the upper limit of each numerical range may be combined with the lower limit of any other numerical range. Feature of the present disclosure

The present disclosure relates to a toner including a toner particle containing a binder resin and an external additive, and the toner is characterized in
(i) that a fragment peak derived from a boron atom and a fragment peak derived from a boron-oxygen structure are detected by TOF-SIMS measurement of the toner,
(ii) that the toner particle contains dodecylbenzenesulfonic acid or a dodecylbenzenesulfonic acid salt, and
(iii) that hydrotalcite is contained as the external additive.

The 1 dot reproducibility is an indicator of whether a latent image is able to be faithfully reproduced with respect to a fine latent image drawn on an electrostatic latent image-bearing member. Regarding the evaluation method, judgement is performed based on whether the dot is drawn when a fine dot image is output (regarding details, refer to the example described later). When the 1 dot reproducibility is improved from the viewpoint of the toner, it is important to enhance the chargeability of the toner. From such a view point, an improvement due to an effect exerted by the hydrotalcite having an effect of improving the chargeability is expected.

However, when the hydrotalcite is simply externally added, the hydrotalcite gets out of the toner, the ratio of the hydrotalcite to the toner is gradually increased in a developing container or the like of an image forming apparatus, the chargeability is fluctuated to a great extent, and the image quality tends to become unstable during long-term use. According to investigation by the present inventors, it was found that when the above-described configuration is adopted, a change in the attachment state of the hydrotalcite is small during long-term use, and the 1 dot reproducibility is significantly improved.

That is, to prevent hydrotalcite from being condensed during long-term use due to detachment from the toner, the present inventors focused attention on electrostatic adhesion and performed intensive investigation.

As a result, it was found that disposing a dodecylbenzenesulfonic acid structure on the toner surface and including a boron-oxygen bond (hereafter referred to as “BO bond”) enable the hydrotalcite to be significantly suppressed from being condensed. This is conjectured to be as described below.

On the toner surface according to the present disclosure, a BO bond and dodecylbenzenesulfonic acid or a dodecylbenzenesulfonic acid salt are present. The BO bond is a functional group having high adsorbability to water, and it is conjectured that water is retained to some extent on the toner surface even in an environment such as a low temperature and low humidity environment in which a water content is low. Further, dodecylbenzenesulfonic acid or a dodecylbenzenesulfonic acid salt is water-soluble and moves into water retained on the toner surface so as to become in a state of being movable in a toner surface portion including water. Herein, regarding the dodecylbenzenesulfonic acid structure, it is conjectured that a sulfonic acid portion is a structure having strong negativity and electrostatically adsorbs to a positive portion of the hydrotalcite. It is conjectured that the above-described effect being exerted enables the hydrotalcite to be suppressed from being condensed.

In the toner according to the present disclosure, the boron atom is present on the toner surface. Specifically, a fragment peak derived from a boron atom is detected by TOF-SIMS measurement of the toner. TOF-SIMS is capable of quantitatively performing measurement with respect to a region within 10 nm from the toner surface. Regarding presence or absence of the boron atom, sodium tetraborate decahydrate produced by FUJIFILM Wako Pure Chemical Corporation serving as a standard sample is subjected to TOF-SIMS measurement in advance. With respect to the measurement data, positions of peaks derived from a boron atom and BO2 (representative structure having a BO bond) are examined in advance.

Thereafter, an object toner is subjected to TOF-SIMS measurement so that presence or absence of a boron atom and a BO bond is determined. When neither boron atom nor BO bond is present, the effect of the present disclosure is not obtained.

In addition, the toner according to the present disclosure contains dodecylbenzenesulfonic acid or a dodecylbenzenesulfonic acid salt. The measurement of dodecylbenzenesulfonic acid will be described later in detail, and presence or absence in the vicinity of the surface and the content in the toner are determined by ESI-MS measurement. When neither dodecylbenzenesulfonic acid nor dodecylbenzenesulfonic acid salt is present, the effect of the present disclosure is not obtained similarly to the BO bond.

The effect of the present disclosure is not exerted until the hydrotalcite is disposed by external addition with respect to the toner surface provided with the BO bond and dodecylbenzenesulfonic acid or a dodecylbenzenesulfonic acid salt.

### Favorable Configuration of the Present Disclosure

The favorable configuration of the present disclosure will be described below.

In the toner according to the present invention, the content (mass basis) of dodecylbenzenesulfonic acid or a dodecylbenzenesulfonic acid salt is preferably 10 ppm or more and 1,000 ppm or less. The content is preferably 10 ppm or more since adsorbing action with respect to the hydrotalcite is sufficiently exerted, and image quality such as 1 dot reproducibility or fogging inhibition characteristic is excellent during long-term use. The content is more preferably 20 ppm or more. On the other hand, although a large amount of compound such as dodecylbenzenesulfonic acid being contained in the toner tends to have an influence on the chargeability, the content is preferably 1,000 ppm or less since image quality such as 1 dot reproducibility or fogging inhibition characteristic is excellent. The content is more preferably 800 ppm or less.

The abundance (mass basis) of boron atom in the toner according to the present disclosure based on an inductively coupled plasma mass spectrometer (ICP-MS) is preferably 0.1 ppm or more and 100 ppm or less since the 1 dot reproducibility is excellent. Quantification of boron atom will be described below, and an amount of boron atom in the toner is determined by ICP-MS measurement. The abundance is more preferably 0.1 ppm or more and 25 ppm or less, further preferably 0.1 ppm or more and 10 ppm or less, and still more preferably 0.1 ppm or more and 2.0 ppm or less.

The toner according to the present disclosure contains hydrotalcite. The content of the hydrotalcite is preferably 0.01 parts by mass or more and 3.00 parts by mass or less relative to 100 parts by mass of the toner particle since the charge rising characteristic is excellent. The content of 0.01 parts by mass or more is sufficient for exerting the effect of the present disclosure. The content is more preferably 0.02 parts by mass or more. When an excessive amount of hydrotalcite is contained, the toner tends to become in an overcharge state. However, when the content is 3.00 parts by mass or less, the toner tends to be readily applied to the present disclosure. The content is more preferably 2.00 parts by mass or less.

In the toner according to the present disclosure, the ratio of hydrotalcite to boron is also an important factor. Specifically, the relationship between the abundance B (ppm) of boron atom and the content H (part by mass) of hydrotalcite can satisfy Formula (1) below.

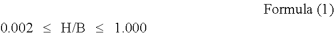

The relationship can be within the above-described range since image quality, such as 1 dot reproducibility at an initial stage and after long-term use and fogging inhibition, is significantly excellent. The lower limit is more preferably 0.010 or more, further preferably 0.020 or more, and still more preferably 0.050 or more. The upper limit is more preferably 0.800 or less.

In addition, the ratio of the content D (ppm) of the dodecylbenzenesulfonic acid or the dodecylbenzenesulfonic acid salt to the content H (part by mass) of the hydrotalcite can also be adjusted. Specifically, the relationship between the two can satisfy Formula (2) below.

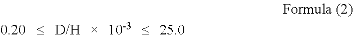

The relationship can be within the above-described range since image quality, such as 1 dot reproducibility at an initial stage and after long-term use and fogging inhibition, is significantly excellent. The range is more preferably 0.25 or more and 25.0 or less.

It is also a favorable configuration that External additive A satisfying (i) and (ii) below is used as an external additive in combination with the hydrotalcite,
(i) a major axis of 300 nm or more and 3,000 nm or less, and
(ii) an aspect ratio of 5.0 or more.

It is indicated that External additive A satisfying (i) and (ii) above is an external additive classified in external additives having a large particle diameter and low resistance and that the structure is spicular. External additive A can be used since overcharge in a low temperature and low humidity environment is suppressed and a change in an amount of charge during long-term use is decreased. The content of External additive A in the toner is preferably 0.1 parts by mass or more and 10 parts by mass or less relative to 100 parts by mass of the toner particle. The lower limit is more preferably 0.5 parts by mass or more. The upper limit is more preferably 8.0 parts by mass or less.

There is no particular limitation regarding External additive A provided that (i) and (ii) above are satisfied. For example, titanium oxide readily satisfies the above-described items, and rutile-type titanium oxide is one of favorable forms.

Titanium oxide (External additive B) that does not apply to External additive A can also be used in combination with External additive A since a change in an amount of charge is readily suppressed. External additive B can have a particle diameter on the toner surface of 20 nm or more and 250 nm or less.

The toner according to the present disclosure can have a polyester resin as a surface layer of the toner particle. The reason for this is that the polyester resin readily retains water in a low-humidity environment and, in combination with presence of a BO bond, tends to suppress overcharge.

Further, the surface layer composed of the polyester resin can have a thickness of 300 nm or more and 700 nm or less. The surface layer having such a thickness retains sufficient water and, in particular, tends to suppress a change in chargeability between before and after endurance so as to maintain the 1 dot reproducibility.

Each component constituting the toner and a method for manufacturing the toner will be described in more detail.

### Binder Resin

The toner particle contains a binder resin. The content of the binder resin can be 50% by mass or more in the total amount of the resin component in the toner particle.

There is no particular limitation regarding the binder resin, and examples include styrene acrylic resins, epoxy resins, polyester resins, polyurethane resins, polyamide resins, cellulose resins, and polyether resins and resin mixtures or composite resins of these. From the viewpoint of low price, availability, and excellent low-temperature fixability, styrene acrylic resins and polyester resins are favorable. Styrene acrylic resins are more favorable.

The polyester resin is obtained by selecting appropriate materials from polyvalent carboxylic acids, polyols, hydroxycarboxylic acids, and the like, combining the resulting materials, and performing synthesis by a known method such as a trans esterification method or a polycondensation method. The polyester resins can include condensation polymerization products of dicarboxylic acids and diols.

The polyvalent carboxylic acids are compounds having two or more carboxy groups in the molecule. Of these, dicarboxylic acids are compounds having two carboxy groups in the molecule and are favorably used.

Examples include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Examples of the polyvalent carboxylic acid other than the above-described dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. Only one type of these may be used, or two or more types of these may be used in combination.

Polyols are compounds having two or more hydroxy groups in the molecule. Of these, diols are compounds having two hydroxy groups in the molecule and are favorably used.

Specific examples include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, butylene oxide, and the like) adducts of the above-described bisphenols.

Of these, alkylene glycols having the carbon number of 2 or more and 12 or less and alkylene oxide adducts of bisphenols are favorable, and alkylene oxide adducts of bisphenols and combinations of alkylene oxide adducts of bisphenols and alkylene glycols having the carbon number of 2 or more and 12 or less are particularly favorable. Examples of the alkylene oxide adduct of bisphenol A include compounds denoted by Formula (A) below.

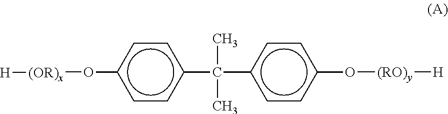

(In Formula (A), each R represents an ethylene or propylene group, each of x and y represents an integer of 0 or more, and an average value of x+y is 0 or more and 10 or less.)

The alkylene oxide adduct of bisphenol A is favorably a propylene oxide adduct and/or an ethylene oxide adduct of bisphenol A. A propylene oxide adduct is more favorable. In this regard, the average value of x+y can be 1 or more and 5 or less.

Examples of the trihydric or higher alcohol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, and cresol novolac and alkylene oxide adducts of the above-described trivalent or higher polyphenols. Only one type of these may be used, or two or more types of these may be used in combination.

Examples of the styrene acrylic resin include monopolymers composed of polymerizable monomers described below, copolymers obtained by combining two or more of these, and mixtures of these.

Styrene-based monomers, such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; (meth)acrylic monomers, such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid; vinyl ether-based monomers, such as vinyl methyl ether and vinyl isobutyl ether; vinyl ketone-based monomers, such as vinyl methyl ketone, vinyl ethyl ketone, and vinyl isopropenyl ketone; and polyolefins, such as ethylene, propylene, and butadiene

Regarding the styrene acrylic resin, as the situation demands, polyfunctional polymerizable monomers may be used. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, and divinyl ether.

In this regard, to control the degree of polymerization, a known chain transfer agent or polymerization inhibitor may be further added. Examples of the polymerization initiator for obtaining the styrene acrylic resin include organic peroxide-based initiators and azo-based polymerization initiator.

Examples of the organic peroxide-based initiator include benzoyl peroxide, lauroyl peroxide, di-α-cumyl peroxide, 2,5-dimethyl-2,5-bis(benzoylperoxy)hexane, bis(4-t-butylcyclohexyl) peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropylperoxycarbonate, cumene hydroperoxide, 2,4-dichlorobenzoyl peroxide, and tert-butyl-peroxypivalate.

Examples of the azo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, and 2,2′-azobis-(methyl isobutyrate).

In addition, a redox-based initiator in which an oxidizing substance and a reducing substance are combined may be used as the polymerization initiator.

Examples of the oxidizing substance include hydrogen peroxide, inorganic peroxides of persulfates (sodium salt, potassium salt, and ammonium salt), and oxidizing metal salts of tetravalent cerium salts.

Examples of the reducing substance include reducing metal salts (divalent iron salts, monovalent copper salts, and trivalent chromium salts), ammonia, lower amines (amines having the carbon number of about 1 or more and 6 or less, such as methylamine and ethylamine), amino compounds, such as hydroxylamine, reducing sulfur compounds, such as, sodium thiosulfate, sodium hydrosulfite, sodium hydrogen sulfite, sodium sulfite, and sodium formaldehyde sulfoxylate, lower alcohols (carbon number of 1 or more and 6 or less), ascorbic acid and salts thereof, and lower aldehydes (carbon number of 1 or more and 6 or less).

The polymerization initiator is selected with reference to the 10-hour half-life temperature, and only one type of the polymerization initiators may be used, or two or more types thereof may be used in combination.

The amount of the polymerization initiator added changes in accordance with the predetermined degree of polymerization. In general, 0.5 parts by mass or more and 20.0 parts by mass or less of polymerization initiator is added relative to 100.0 parts by mass of the polymerizable monomer.

The toner according to the present disclosure can have a configuration in which the binder resin is a styrene acrylic resin, and a polyester resin is included as a shell layer since a good chargeability balance is kept and the 1 dot reproducibility is excellent.

### Mold Release Agent

A known wax may be used as a mold release agent for the toner.

Specific examples include petroleum-based wax represented by paraffin wax, microcrystalline wax, and petrolatum and derivatives thereof, montan wax and derivatives thereof, hydrocarbon wax by the Fischer-Tropsch method and derivatives thereof, polyolefin wax represented by polyethylene and derivatives thereof, and natural wax represented by carnauba wax and candelilla wax and derivatives thereof, and derivatives include oxides, block copolymers with vinyl monomers, and graft-modified materials.

In addition, examples include alcohols such as higher fatty alcohols; fatty acids such as stearic acid and palmitic acid or acid amides, esters, or ketones thereof; hardened caster oil and derivatives thereof, plant wax, and animal wax. Only one type of these may be used, or two or more types of these may be used in combination.

Of these, polyolefin, hydrocarbon wax by the Fischer-Tropsch method, or petroleum-based wax can be used since developability and transferability tend to be improved. In this regard, an antioxidant may be added to these waxes within the bounds of not exserting an influence on the effect of the toner. In addition, from the viewpoint of phase separability with respect to the binder resin or a crystallization temperature, higher fatty acid esters, such as behenyl behenate and dibehenyl sebacate, can be exemplified.

The content of the mold release agent can be 1.0 parts by mass or more and 30.0 parts by mass or less with respect to 100.0 parts by mass of the binder resin.

The melting point of the mold release agent is preferably 30° C. or higher and 120° C. or lower and more preferably 60° C. or higher and 100° ° C. or lower. When the mold release agent having the above-described thermal characteristics is used, a mold release effect is efficiently realized, and a wider fixing region is ensured.

### Plasticizer

The toner particle may contain a crystalline plasticizer to improve the sharp melting property. There is no particular limitation regarding the plasticizer, and known plasticizers, as described below, used for the toner may be used.

Specific examples include esters of monohydric alcohol and fatty carboxylic acid or esters of monovalent carboxylic acid and fatty alcohol, such as behenyl behenate, stearyl stearate, and palmityl palmitate; esters of dihydric alcohol and fatty carboxylic acid or esters of divalent carboxylic acid and fatty alcohol, such as ethylene glycol distearate, dibehenyl sebacate, and hexanediol dibehenate; esters of trihydric alcohol and fatty carboxylic acid or esters of trivalent carboxylic acid and fatty alcohol, such as glycerin tribehenate; esters of tetrahydric alcohol and fatty carboxylic acid or esters of tetravalent carboxylic acid and fatty alcohol, such as pentaerythritol tetrastearate and pentaerythritol tetrapalmitate; esters of hexahydric alcohol and fatty carboxylic acid or esters of hexavalent carboxylic acid and fatty alcohol, such as dipentaerythritol hexastearate and dipentaerythritol hexapalmitate; esters of polyhydric alcohol and fatty carboxylic acid or esters of polyvalent carboxylic acid and fatty alcohol, such as polyglycerin behenate; and natural wax, such as carnauba wax and rice wax. Only one type of these may be used, or two or more types of these may be used in combination.

### Coloring Agent

The toner particle may contain a coloring agent. Known pigments and dyes may be used as the coloring agent. The coloring agent can be a pigment from the viewpoint of excellent weatherability.

Examples of the cyan-based coloring agent include copper phthalocyanine compounds and derivatives thereof, anthraquinone compounds, and basic dye lake compounds.

Specific examples include C.I. Pigment Blue 1, 7, 15, 15:1, 15:2, 15:3, 15:4, 60, 62, and 66.

Examples of the magenta-based coloring agent include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254 and C.I. Pigment Violet 19.

Examples of the yellow-based coloring agent include condensed azo compounds, isoindolinone compounds, anthraquinone compounds, azo metal complexes, methine compounds, and allylamide compounds.

Specific examples include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of the black coloring agent include coloring agents adjusted to black by using the above-described yellow-based coloring material, magenta-based coloring agent, and cyan-based coloring agent, carbon black, and magnetic materials.

Only one type of the coloring agents may be used, or two or more types thereof may be used in combination. Further, these may be used in a solid solution state. Favorably, 1.0 parts by mass or more and 20.0 parts by mass or less of the coloring agent relative to 100.0 parts by mass of the binder resin is used. In this regard, when a manufacturing method in a water-based medium, described later, by using a magnetic material is applied, hydrophobization treatment may be performed to stably contain the magnetic material in the resin.

### Charge Control Agent and Charge Control Resin

The toner particle may contains a charge control agent or a charge control resin. The charge control agent or the charge control resin can have negative chargeability.

Examples of the material for controlling the toner so as to have negative chargeability include monoazo metal compounds; acetylacetone metal compounds; aromatic oxycarboxylic acids; aromatic dicarboxylic acids; oxycarboxylic acid- and dicarboxylic acid-based metal compounds; aromatic mono or polycarboxylic acid and metal salts thereof, anhydrides, esters; phenol derivatives such as bisphenol; urea derivatives; metal-containing salicylic acid-based compounds; metal-containing naphthoic acid-based compounds; boron compounds; quaternary ammonium salts; calixarenes; and charge control resins.

Examples of the charge control resin include polymers and copolymers having a sulfonic acid group, a sulfonic acid salt group, or a sulfonic ester group. The polymers having a sulfonic acid group, a sulfonic acid salt group, or a sulfonic ester group are, in particular, polymers containing a sulfonic acid group-containing acrylamide-based monomer or a sulfonic acid group-containing methacrylamide-based monomer at a copolymerization ratio of preferably 2% by mass or more and more preferably 5% by mass or more.

The charge control resin can have a glass transition temperature (Tg) of 35° ° C. or higher and 90° C. or lower, a peak molecular weight (Mp) of 10,000 or more and 30,000 or less, and a weight average molecular weight (Mw) of 25,000 or more and 50,000 or less. Using the charge control resin enables favorable triboelectric charge characteristics to be provided without exerting influence on the thermal characteristics required of the toner particle. in addition, the charge control resin having a sulfonic acid group improves the dispersibility of the charge control resin itself in, for example, a polymerizable monomer composition, improves the dispersibility of the coloring agent and the like, and enables the coloring power, the transparency, and the triboelectric charge characteristics to be further improved.

Only one type of the charge control agents and the charge control resins may be used, or two or more types of these may be used in combination. The amount of the charge control agent or the charge control resin added is preferably 0.01 parts by mass or more and 20.0 parts by mass or less and more preferably 0.5 parts by mass or more and 10.0 parts by mass or less relative to 100.0 parts by mass of the binder resin.

### Method for Manufacturing Toner

There is no particular limitation regarding the method for manufacturing the toner, and known methods, such as a pulverization method, a suspension polymerization method, a dissolution suspension method, an emulsion aggregation method, and a dispersion polymerization method may be used. To obtain the toner according to the present disclosure, an optional manufacturing method may be applied.

To obtain a structure having a BO bond on the toner surface, a method in which a compound having a BO bond is used and oriented on the surface in a water-based medium or attached to the toner particle in an external addition step or the like described later is considered. An optional compound may be used as the compound having a BO bond, and a boron compound is easy to handle and can be used. Examples of the boron compound include sodium tetraborate, borax, and ammonium borate.

In this regard, to arrange dodecylbenzenesulfonic acid or a dodecylbenzenesulfonic acid salt on the toner surface, it is considered to add such a compound. When the content of the dodecylbenzenesulfonic acid structure is quantitatively controlled, a method in which, after the toner particle is produced, addition is performed in an external addition step or the like described later is considered. Sodium dodecylbenzenesulfonate, lithium dodecylbenzenesulfonate potassium dodecylbenzenesulfonate, magnesium dodecylbenzenesulfonate, and calcium dodecylbenzenesulfonate can be used as the dodecylbenzenesulfonic acid salt.

### External Addition Step

In the external addition step, hydrotalcite or another external additive is externally added to the toner particle. As the situation demands, other external additives may be added.

Specific examples of other external additives include inorganic fine particles of silica and the like and resin fine particles of vinyl-based resins, polyester resins, silicone resins, and the like. These external additives can be added while, for example, shear force is applied in a dry state. In this regard, as described above, External additive A satisfying (i) and (ii) above may be used in combination with the hydrotalcite. Further, titanium oxide (External additive B) that does not apply to External additive A can also be used in combination with External additive A.

The toner according to the present disclosure can have negative chargeability to combine with the above-described binder resin. In such an instance, the charge control agent or the charge control resin having negative chargeability can be used to adjust the toner having negative chargeability.

The weight average particle diameter of the toner is preferably 6 μm or more and 10 μm or less since chargeability is excellent, more preferably 6 μm or more and 9 μm or less, and further preferably 7 μm or more and 9 μm or less.

### Method for Measuring Each Physical Property

Next, a method for measuring each physical property will be described. Method for measuring fragment peaks derived from boron atom and BO structure

Fragment peaks derived from a boron atom and a BO structure in the toner are detected using TOF-SIMS.

TRIFT-IV produced by ULVAC-PHI, Inc. is used for fragment ion measurement on the toner surface by using TOF-SIMS. The analysis conditions are as described below.
Preparation of sample: silica fine particles are attached to an indium sheet
Primary ion: Au ion
Acceleration voltage: 30 kV
Charge neutralization mode: On
Measurement mode: Positive
Raster: 200 μm
Measurement time: 60 s

Regarding the mass profile of the acquired secondary ion mass/secondary ion charge number (m/z), whether a fragment ion derived from a boron atom is observed is examined. In this regard, in the present disclosure, presence or absence of a BO bond is determined by presence or absence of a mass profile of BO2 based on the peak intensity balance.

### Determination of Presence or Absence of Dodecylbenzenesulfonic Acid or Dodecylbenzenesulfonic Acid Salt in Toner

Presence or absence of dodecylbenzenesulfonic acid or a dodecylbenzenesulfonic acid salt is determined by performing analysis by the MS/MS (mass mass) method using a tandem mass spectrometer directly connected with a liquid chromatograph ESI/MS analyzer.

The MS/MS method is mass spectrometry which is capable of detecting a fragment having a smaller molecular weight by measuring a fragment taken in the first analysis system by using the second analysis system and which is capable of readily performing structure analysis of a specimen.
Elution condition A: Methanol (equivalent of product standardized in JIS K 8891) in an amount 10 times the toner on a mass basis is used and agitation is performed at 25° C. for 10 hours by using an agitation apparatus at a rotor rotation speed of 200 rpm.
Centrifugal separation condition A: Rotation is performed at 25° ° C. for 30 min at a rotation radius of 10.1 cm and a rotation speed of 3,500 rpm.

Regarding the specimen, the toner is used and adjusted under Elution condition A above. The resulting specimen is separated into a solid content and a supernatant liquid under Centrifugal separation condition A above.

The supernatant liquid obtained by the above-described adjustment is supplied to a measuring apparatus described below, and liquid chromatograph ESI/MS analysis is performed under Analysis condition B described below. A mass spectroscopy spectrum of an anion is obtained, and it is checked that a peak is detected at m/z=325. An ion detected as a peak at m/z=325 is supplied as precursor ion to a tandem mass spectrometer, and an MS/MS spectrum is acquired under Analysis condition B.
Measuring apparatus: Ultimate 3000 (produced by Thermo Fisher Scientific)
Mass spectrometer: LCQ Fleet (produced by Thermo Fisher Scientific)
Analysis condition B: Under the conditions described below, anions which are ionized under the conditions of a capillary voltage: −35 V and a tube lens voltage: −110 V are detected, an ion detected at m/z=325 is selected as the precursor ion, and an ion resulting from collision-induced dissociation with respect to an inert gas: He at collision energy: 35 eV is detected.
Ionization method: an electrospray method (ESI)
Sheath Gas: 10 (arb. unit.)
Aux Gas: 5 (arb. unit.)
Spray voltage: 5 kV
Capillary temperature: 275° C.
Mobile phase: methanol (equivalent of product standardized in JIS K 8891)
Column: non use (a stationary phase is not used)
Flow rate: 1 ml/min
Injection amount: 10 μl
Chromatogram detector: UV detector
MS acquisition time: 5 min
MS measurement range: 50 to 1,500 m/z
Collision inert gas: helium (He)
Collision energy: 35 e V

### Quantification of Dodecylbenzenesulfonic Acid or Dodecylbenzenesulfonic Acid Salt in Toner

Quantification of dodecylbenzenesulfonic acid or a dodecylbenzenesulfonic acid salt in the toner is performed by subjecting a methanol extract of the toner to the LC/MS measurement. A calibration curve is formed by using sodium dodecylbenzenesulfonate as a standard specimen, and quantification is performed.

### LC/MS Analysis Condition

Model: Agilent 6130 Quadropole LC/MS (produced by Agilent Technologies)
Eluent: methanol
Column: ZORBAX Eclipse Plus C18 (1.8 μm, 100×4.6 mmI.D.) (produced by Agilent Technologies), flow rate: 1.0 mL/min
Column temperature: 30° C.

### Measurement of Abundance of Boron Atom in Toner

The content of boron atoms on the toner particle surface is measured by using an inductively coupled plasma mass spectrometer (ICP-MS (produced by Agilent Technologies)).

Regarding pretreatment, a 6.0-mol/L nitric acid aqueous solution is prepared using 60% nitric acid (grade of Ultrapure, produced by KANTO CHEMICAL CO., INC.) and ultrapure water. A toner-containing solution sample is produced by adding 5.00 g of 6.0-mol/L nitric acid aqueous solution to 50.0 mg of toner and performing agitation. After the sample is left to stand for 120 min, filtration is performed using filter paper having a pore diameter of 1 μm so as to produce a toner cake. Thereafter, 10.00 g of ultrapure water serving as washing water is added to the toner cake, and the toner is separated from the toner-containing solution sample. A boron atom measurement solution sample is produced by adding ultrapure water to the solution sample which is the filtrate so as to set the total amount to be 50.00 g.

A calibration curve is formed by preparing a blank solution sample in which ultrapure water is added to 5.00 g of 6.0-mol/L nitric acid aqueous solution so as to set the total amount to be 50.00 g and a solution sample having a known boron atom content. The content of the boron atom on the toner surface is measured by quantifying the boron atom contained in the boron atom measurement solution sample.

### Determination of Presence or Absence of Hydrotalcite Particle

Determination of presence or absence of a hydrotalcite particle may be performed by combination of shape observation by using a scanning electron microscope (SEM) and element analysis by using energy dispersive X-ray analysis (EDS).

The toner is observed in an enlarged field of view at a magnification of up to 50,000 times by using a scanning electron microscope “S-4800” (trade name, produced by Hitachi, Ltd.). The focus is placed on the toner particle surface, and an external additive which is the object of determination is observed. The external additive which is the object of determination is subjected to EDS analysis, and a silica particle and a hydrotalcite particle are identified based on the type of the element peak.

When an element peak of at least one metal selected from the group consisting of Mg, Zn, Ca, Ba, Ni, Sr, Cu, and Fe which are metals capable of constituting a hydrotalcite particle and an element peak of at least one metal selected from the group consisting of Al, B, Ga, Fe, Co, and In are observed as element peaks, it is estimated that a hydrotalcite particle containing the two types of metals is present.

A standard specimen of the hydrotalcite particle estimated by the EDS analysis is separately prepared, and shape observation by using the SEM and the EDS analysis are performed. Comparisons whether the analysis results of the standard specimen are in accord with the analysis results of the particle which is the object of determination are performed, and whether the object of determination is a hydrotalcite particle is determined.

### Quantification of Hydrotalcite

The content of the hydrotalcite particle is determined by calculation based on the intensity of the metal element derived from the hydrotalcite particle by using an X-ray fluorescence analyzer (XRF). The content of the hydrotalcite particle is calculated based on analysis of the intensity of the element identified by STEM-EDS mapping analysis. The measurement procedure is described below.

Regarding a measuring apparatus, a wavelength-dispersive X-ray fluorescence analyzer “Axios” (produced by PANalytical) and attached software “SuperQ ver. 4.0F” (produced by PANalytical) for setting measurement conditions and analyzing measurement data are used. In this regard, Rh is used as an anode of an X-ray tube, a measurement atmosphere is a vacuum, and a measurement diameter (collimator mask diameter) is set to be 27 mm. When a light element is measured, detection is performed by using a proportional counter (PC), and when a heavy element is measured, detection is performed by using a scintillation counter (SC).

Likewise, the content Wh of the hydrotalcite particle is calculated based on analysis of the intensity of the element identified by the STEM-EDS mapping analysis. Measurement of abundance of External additive A in toner

The major axis (maximum diameter) and the aspect ratio of External additive A are determined using a scanning electron microscope (for example, a scanning electron microscope “S-4800” (trade name, produced by Hitachi, Ltd.). In an enlarged field of view at a magnification of up to 50,000 times, only the external additive having a major diameter of 300 nm or more and 3,000 nm or less are selected and observed, the major diameters and the minor diameters of random 100 primary particles of the external additive are measured, and calculation is performed. The particles having an aspect ratio of 5.0 or more are assumed to be External additive A. In this regard, the aspect ratio is calculated by dividing the major axis by the minor axis.

### Measurement of Abundance of External Additive B in Toner

The major axis (maximum diameter) of External additive B is determined using a scanning electron microscope (for example, a scanning electron microscope “S-4800” (trade name, produced by Hitachi, Ltd.). In an enlarged field of view at a magnification of up to 50,000 times, only the external additive having a major diameter of 20 nm or more and 250 nm or less are selected and observed, and the major diameters of random 100 primary particles of the external additive are measured.

Further, whether the external additive is titanium oxide is determined by combining element analysis by using energy dispersive X-ray analysis (EDS).

The toner is observed in an enlarged field of view at a magnification of up to 50,000 times by using a scanning electron microscope “S-4800” (trade name, produced by Hitachi, Ltd.). The focus is placed on the toner particle surface, and an external additive which is the object of determination is observed. The external additive which is the object of determination is subjected to the EDS analysis, and whether the external additive is titanium oxide is determined based on the element peak.

### Measurement of Weight Average Particle Diameter (D4) and Number Average Particle Diameter (D1) of Toner or Toner Particle

The weight average particle diameter (D4) and the number average particle diameter (D1) of the toner or the toner particle are measured by using an accurate particle size distribution analyzer “Coulter Counter Multisizer 3” (registered trademark, produced by Beckman Coulter, Inc.) which is provided with an aperture tube of 100 μm and which is based on an aperture impedance method and attached dedicated software “Beckman Coulter Multisizer 3 Version 3.51” (produced by Beckman Coulter, Inc.) for setting the measurement conditions and analyzing measurement data. The measurement is performed with the number of effective measurement channels of 25,000, the measurement data are analyzed, and calculation is performed.

Regarding an electrolytic aqueous solution used for the measurement, a solution in which analytical grade sodium chloride is dissolved into deionized water so as to have a concentration of about 1% by mass, for example, “ISOTON II” (produced by Beckman Coulter, Inc.) is used.

Before the measurement and the analysis are performed, the dedicated software is set as described below.

In a “Changing standard operation method (SOM)” screen of the dedicated software, the total count number in the control mode is set to be 50,000 particles, the number of measurements is set to be 1, and a Kd value is set to be a value obtained by using “Standard particles 10.0 μm” (produced by Beckman Coulter, Inc.). A threshold value and a noise level are automatically set by pushing a “Threshold value/noise level measurement button”. In addition, Current is set to be 1,600 HA, Gain is set to be 2, Electrolytic solution is set to be ISOTON II, and “Flush of aperture tube after measurement” is checked.

In a “Setting conversion from pulse to particle diameter” screen of the dedicated software, Bin interval is set to be logarithmic particle diameter, Particle diameter bin is set to be 256 particle diameter bin, and Particle diameter range is set to be 2 μm or more and 60 μm or less.

Specific measuring method is as described below.
(1) A 250 ml round-bottom glass beaker dedicated to Multisizer 3 is charged with about 200 ml of the electrolytic aqueous solution, the beaker is set into a sample stand, and counterclockwise agitation with a stirrer rod is performed at 24 rotations/sec. Subsequently, contamination and air bubbles in an aperture tube are removed by a “Flush of aperture tube” function of the dedicated software.
(2) A 100 ml flat-bottom glass beaker is charged with about 30 ml of the electrolytic aqueous solution. To the beaker, about 0.3 ml of diluted liquid prepared by diluting a dispersing agent “Contaminon N” (10% by mass aqueous solution of neutral detergent for precision measurement appliance cleaning which includes a nonionic surfactant, an anionic surfactant, and an organic builder and which has a pH of 7, produced by Wako Pure Chemical Industries, Ltd.) with deionized water by a factor of 3 on a mass basis is added.
(3) An ultrasonic dispersion device “Ultrasonic Dispersion System Tetora 150” (produced by Nikkaki Bios Co., Ltd.) that includes two oscillators having an oscillation frequency of 50 kHz, with their phases shifted by 180° from each other, and that has an electrical output of 120 W is prepared. A water tank of the ultrasonic dispersion device is charged with a predetermined amount of deionized water, and about 2 ml of Contaminon N is added to the water tank.
(4) The beaker according to (2) above is set into a beaker fixing hole of the ultrasonic dispersion device, and the ultrasonic dispersion device is operated. Subsequently, the height position of the beaker is adjusted so that the resonance state of the liquid surface of the electrolytic aqueous solution in the beaker becomes at a maximum level.
(5) In the state in which the electrolytic aqueous solution in the beaker according to (4) above is irradiated with ultrasonic waves, about 10 mg of toner or toner particles are added gradually to the electrolytic aqueous solution and are dispersed. Subsequently, the ultrasonic dispersion treatment is continued for further 60 sec. In this regard, during the ultrasonic dispersion, the water temperature of the water tank is appropriately adjusted to become 10° C. or higher and 40° C. or lower.
(6) The electrolytic aqueous solution, according to (5) above, containing dispersed toner or toner particles is dripped to the round-bottom beaker, according to (1) above, set into the sample stand by using a pipette so that the measured concentration is adjusted to about 5%. Subsequently, the measurement is performed until the number of measured particles reaches 50,000.
(7) The weight average particle diameter (D4) is calculated by analyzing the measurement data with the dedicated software attached to the apparatus. In this regard, an “Average diameter” on an “Analysis/volume statistical value (arithmetic mean)” screen, where graph/volume % is set in the dedicated software, corresponds to the weight average particle diameter (D4), and an “Average diameter” on an “Analysis/number statistical value (arithmetic mean)” screen, where graph/number % is set in the dedicated software, corresponds to the number average particle diameter.

### EXAMPLES

The present disclosure will be described below in more detail with reference to the examples and the comparative examples, but the disclosure is not limited to these. “Part” used for the combination in the examples is on a mass basis, unless otherwise specified.

### Production of Magnetic Material 1

A high-speed mixer (Model LFS-2 produced by FUKAE POWTECK CO., LTD.) was charged with 100 parts of magnetic iron oxide, and 8.0 parts of an aqueous solution containing a silane compound was dripped over 2 min while agitation was performed at a rotation speed of 2,000 rpm. Thereafter, mixing and agitation were performed for 5 min.

Subsequently, to improve the fixability of a silane compound, drying was performed at 40° ° C. for 1 hour so as to decrease the water content, and a condensation reaction of the silane compound was advanced by drying the mixture at 110° C. for 3 hours. Thereafter, disintegration was performed, and Magnetic material 1 was obtained by being passed through a sieve having openings of 100 μm.

### Production Example of Polyester Resin A

A reaction apparatus provided with an agitator, a thermometer, and an effluent cooler was charged with 20 parts of propylene-oxide-modified bisphenol A (2 mol adduct), 80 parts of propylene-oxide-modified bisphenol A (3 mol adduct), 20 parts of terephthalic acid, 20 parts of isophthalic acid, and 0.50 parts of tetrabutoxytitanium, and an esterification reaction was performed at 190° ° C.

Thereafter, 1 part of trimellitic anhydride (TMA) was added, the temperature was increased to 220° C. while the interior of the system was gradually decompressed, and a polycondensation reaction was performed at 150 Pa so as to obtain Polyester resin A. Polyester resin A had an acid value of 12 mgKOH/g and a softening point of 110° ° C.

### Preparation of Hydrotalcite Particle

An aqueous solution mixture (A-liquid) of 1.03 mol/L of magnesium chloride and 0.239 mol/L of aluminum sulfate, 0.753 mol/L of sodium carbonate aqueous solution (B-liquid), and 3.39 mol/L of sodium hydroxide aqueous solution (C-liquid) were prepared.

Regarding the A-liquid, the B-liquid, and the C-liquid, a metering pump was used, the A-liquid and the B-liquid were introduced into a reaction tank at flow rates so that A-liquid:B-liquid was set to be 4.5:1 on a volume ratio basis, the pH value of the reaction liquid was maintained within the range of 9.3 to 9.6 by the C-liquid, and the reaction temperature was set to be 40° ° C. so as to generate a precipitate. The precipitate was filtered, washed, and emulsified again in deionized water so as to obtain a hydrotalcite slurry serving as a raw material. The concentration of hydrotalcite in the resulting hydrotalcite slurry was 5.6% by mass.

Thereafter, filtration was performed by using a membrane filter having a pore diameter of 0.5 μm, and washing with deionized water was performed.

The resulting hydrotalcite was vacuum-dried at 40° C. for a night, and disintegration treatment was performed so as to obtain the hydrotalcite particle.

### Production Example of External Additive A

External additive A was produced as described below. A 50%-NaOH aqueous solution was added to metatitanic acid obtained by a sulfuric acid method so that the amount of NaOH added was 4 times the amount of TiO₂ on a mole basis, and heating was performed at 95° C. for 2 hours. The resulting material was sufficiently washed. Thereafter, 31%-HCl was added so that HCl/TiO₂=0.26 applied, and heating was performed at a boiling temperature for 1 hour. After cooling, neutralization to pH of 7 was performed with 1-mol/L-NaOH, and washing and drying were performed so as to produce fine particle titanium oxide. The specific surface area of the resulting fine particle titanium oxide was 115 g/m².

Addition of 100 parts of NaCl and 25 parts of Na₂P₂O₇.10H₂O to 100 parts of the resulting fine particle titanium oxide was performed, mixing was performed for 1 hour by using a vibration ball mill, and the resulting mixture was fired in an electric furnace at 850° C. for 2 hours.

The resulting fired material was introduced into pure water and heated at 80ºC for 6 hours, and washing was performed so as to remove a soluble salt. All particles obtained by drying had a minor axis within the range of 30 nm or more and 70 nm or less and a major axis within the range of 400 nm or more and 800 nm or less. Therefore, fine-particle spicular titanium oxide (External additive A) satisfying an aspect ratio of 5.0 or more was obtained.

### Production Example of Toner Particle 1

The tone particle was produced in the following procedure.

### Preparation of First Water-Based Medium

TK HOMO MIXER (produced by Tokushu Kika Kogyo Co., Ltd.) was used, 2.9 parts of sodium phosphate dodecahydrate was introduced into 353.8 parts of deionized water, the temperature was increased to 60° C. under agitation, and a calcium chloride aqueous solution in which 1.7 parts of calcium chloride dihydrate was added to 11.7 parts of deionized water and a magnesium chloride aqueous solution in which 0.5 parts of magnesium chloride was added to 15.0 parts of deionized water were added while agitation was continued so as to obtain a first water-based medium containing a dispersion stabilizer.

### Preparation of Polymerizable Monomer Composition

| | | |
|---|---|---|
| Styrene | 75.0 | parts |
| n-Butyl acrylate | 25.0 | parts |
| 1,6-Hexanediol diacrylate | 0.5 | parts |
| Magnetic material 1 | 95.0 | parts |
| Polyester resin A | 3.0 | parts |

### Negative-Charging Charge Control Resin (FCA-N Produced by Fujikura Kasei Co., Ltd.) 1.0 Part

The above-described materials were homogeneously dispersed and mixed using Attritor (produced by Mitsui Miike Chemical Engineering Machinery Co., Ltd.). The temperature was increased to 60° C., and 15.0 parts of behenyl stearate wax (melting point of 68° C.) serving as ester wax and 8.0 parts of paraffin wax (HNP-9 produced by NIPPON SEIRO CO., LTD.) serving as hydrocarbon wax were added thereto, mixed, and dissolved so as to obtain a polymerizable monomer composition.

### Preparation of Second Water-Based Medium

A paddle stirring blade was used, 0.6 parts of sodium phosphate dodecahydrate was introduced into 166.8 parts of deionized water, the temperature was increased to 60° ° C. under agitation, and a calcium chloride aqueous solution in which 0.3 parts of calcium chloride dihydrate was added to 2.3 parts of deionized water was added while agitation was continued so as to obtain a second water-based medium containing a dispersion stabilizer.

### Granulation

The above-described polymerizable monomer composition was introduced into the above-described first water-based medium, the resulting granulation liquid was treated for 1 hour by using CAVITRON (produced by YUROTEC LIMITED) at a peripheral speed of rotor of 29 m/s so as to perform homogeneous dispersion and mixing, 7.0 parts of t-butyl peroxypivalate serving as a polymerization initiator was further introduced, and granulation was performed using Cleamix (produced by M Technique Co., Ltd.) at a peripheral speed of 22 m/s for 10 min under agitation in a N2 atmosphere at 60° ° C. so as to obtain a granulation liquid containing a droplet of the polymerizable monomer composition.

### Polymerization/Distillation/Drying/External Addition

The above-described polymerizable liquid was introduced into the above-described second water-based medium, and a reaction was performed at 74° C. for 3 hours under agitation with a paddle stirring blade. After the reaction was completed, the temperature was increased to 98° C., and a reaction slurry was obtained by performing distillation for 3 hours. Thereafter, a cooling step of introducing water at 0° C. into the reaction slurry and cooling the reaction slurry from 98° C. to 45° C. at a rate of 100° C./min was performed. Subsequently, the temperature was increased to 50° C. and maintained for 3 hours.

Thereafter, the reaction slurry was left to stand at room temperature so as to be cooled to 25° C. The resulting reaction slurry was washed by adding chloric acid, and filtration and drying were performed so as to obtain Toner particle 1-1 having a weight average particle diameter of 7.7 μm.

Subsequently, Toner particle 1-2 was obtained by subjecting Polyester resin A (17 parts) and Toner particle 1-1 (100 parts) to external addition while the temperature was increased to 48° ° C. by using FM 10C (produced by NIPPON COKE & ENGINEERING CO., LTD.). When a cross section of Toner particle 1-2 was observed, a shell was formed of Polyester resin A, and the average thickness was 530 nm.

A 1%-aqueous solution of sodium tetraborate decahydrate (produced by FUJIFILM Wako Pure Chemical Corporation) was sprayed to Toner particle 1-2 obtained above so that the boron content in the toner was set to be 1.0 ppm. Further, a 1%-aqueous solution of sodium dodecylbenzenesulfonate (product name: NEOGEN RK produced by Dai-ichi Kogyo Seiyaku Co., Ltd.) was sprayed so that the dodecylbenzenesulfonic acid content in the toner was set to be 500 ppm. As a result, Toner particle 1 was obtained.

### Production Example of Toner 1

The hydrotalcite particle (0.10 parts), the silica particle which was treated with dimethylsilicone oil and which had a BET specific surface area of 150 m²/g (1.50 parts), External additive A (0.50 parts), and the titanium oxide particle having a particle diameter of 150 nm (0.20 parts) were externally added to and mixed with Toner particle 1 (100.0 parts) obtained above by using FM 10C (produced by NIPPON COKE & ENGINEERING CO., LTD.). Regarding the condition for external addition, a lower blade was an AO blade, the distance from a deflector wall was set to be 20 mm, and the amount of toner particle charged: 2.0 kg, the number of rotation: 66.6 s⁻¹, the external addition time: 10 min, cooling water temperature of 20° ° C., and cooling water flow rate of 10 L/min were adopted.

Thereafter, Toner 1 having a weight average particle diameter of 7.8 μm was obtained by performing sieving with a mesh having openings of 200 μm. In this regard, the weight average particle diameter of each of Toners 2 to 18 below was 7.6 to 7.9 μm.

### Production Examples of Toner Particles 2 and 3

Toner particle 2 was obtained in the manner akin to the manner of Toner particle 1-2 except that the amount of Polyester resin A introduced in Production example of Toner particle 1-2 was adjusted so as to set the thickness of the shell to be 700 nm. Toner particle 3 was obtained by performing adjustment so as to set the thickness of the shell to be 300 nm.

### Production Examples of Toner Particles 4 to 17

Toner particles 4 to 17 were obtained in the manner akin to the manner of the production example of Toner particle 1 except that no polyester resin was added to Toner particle 1-1 and that the negative-charging charge control resin was changed to a negative-charging charge control agent (T-77: produced by Hodogaya Chemical Co., Ltd.). In this regard, the dodecylbenzenesulfonic acid content and the boron content are presented in Table 1.

### Production Examples of Toners 2 to 18

Toners 2 to 18 were obtained by performing external addition in accordance with combinations presented in Table 1 in the production example of Toner 1.

### Example 1

Toner 1 was used, and actual machine evaluation was performed as described below. The evaluation results are presented in Table 2.

### Evaluation of Dot Reproducibility

Regarding Toner 1, in a low-temperature low-humidity environment (under LL of 15° C. and 10%) which is considered to be severer for dot reproducibility, halftone (30H) images were formed before and after printing of 10,000 sheets of test charts with a printing rate of 5%, and unevenness of the image was evaluated in accordance with the following criteria.

In this regard, 30H image is a value expressed in a hexadecimal number with respect to 256 tones and is a halftone image when 00H represents solid white (non-image) and FFH represents solid black (full-page image). Regarding the image, Digital microscope VHX-500 (lens of wide range zoom lens VH-Z100, produced by KEYENCE CORPORATION) was used, and areas of 1,000 dots were measured. The number average dot area (S) and the standard deviation (o) of the dot areas were calculated, and a dot reproducibility index was calculated by the following formula.

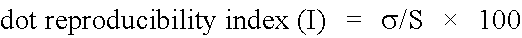

### Evaluation Criteria

A: I is less than 2.0
B: I is 2.0 or more and less than 4.0
C: I is 4.0 or more and less than 6.0
D: I is 6.0 or more and less than 8.0
E: I is 8.0 or more

When the evaluation was performed, modified HP LaserJet Enterprise M609dn having a process speed of 410 mm/sec was used.

In this regard, Vitality (produced by Xerox, basis weight of 75 g/cm2, letter size) was used as the evaluation paper.

### Evaluation of Fogging Suppression

A sheet of solid white image was output each of before and after 10,000 sheets of printing described above, and evaluation was performed by the following method. In this regard, measurement was performed using a reflectometer (trade name: Reflectometer Model TC-6DS produced by Tokyo Denshoku Co., Ltd.). The minimum value of reflection density of a white ground portion of the solid white image before output of 10,000 sheets was acquired. In addition. the reflection density of unused paper was measured. The difference thereof was assumed to be an amount of fogging. A change in the amount of fogging between before and after output of 10,000 sheets was rated in accordance with the following criteria.

### Evaluation Criteria

A: difference in amount of fogging is less than 0.5
B: difference in amount of fogging is 0.5 or more and less than 1.0
C: difference in amount of fogging is 1.0 or more and less than 1.5
D: difference in amount of fogging is 1.5 or more and less than 2.0
E: difference in amount of fogging is 2.0 or more

### Evaluation of Charge Maintainability

The amount of charge (μC/g) of the toner on a developer-bearing member in a toner cartridge was measured using a blow-off powder electrostatic charge measuring apparatus TB-200 (produced by Toshiba Chemical Corporation) before and after 10,000 sheets of printing described above. The toner has stable dot reproducibility with decreasing rate of increase in the amount of charge since condensation of the hydrotalcite decreases.

### Examples 2 to 15 and Comparative Examples 1 to 3

Evaluations in Examples 2 to 15 and Comparative examples 1 to 3 were performed in the manner akin to the manner in Example 1 except that Toner 1 was changed to toners 2 to 18, respectively. The results are presented in Table 2.

TABLE 1

| | | | | | | | Content of |
|---|---|---|---|---|---|---|---|
| | | | | Presence | Presence of | Presence | dodecylbenzenesulfonic |
| | | | Presence | of | dodecylbenzenesulfonic | of | acid |
| | Toner | Base | of | BO | acid | hydrotalcite | structure |
| | No. | material | boron | bond | structure | particle | [D]/ppm |
| Example 1 | Toner 1 | Toner | detected | yes | yes | yes | 500 |
| | | particle 1 | | | | | |
| Example 2 | Toner 2 | Toner | detected | yes | yes | yes | 500 |
| | | particle 2 | | | | | |
| Example 3 | Toner 3 | Toner | detected | yes | yes | yes | 500 |
| | | particle 3 | | | | | |
| Example 4 | Toner 4 | Toner | detected | yes | yes | yes | 20 |
| | | particle 4 | | | | | |
| Example 5 | Toner 5 | Toner | detected | yes | yes | yes | 800 |
| | | particle 5 | | | | | |
| Example 6 | Toner 6 | Toner | detected | yes | yes | yes | 10 |
| | | particle 6 | | | | | |
| Example 7 | Toner 7 | Toner | detected | yes | yes | yes | 1000 |
| | | particle 7 | | | | | |
| Example 8 | Toner 8 | Toner | detected | yes | yes | yes | 1000 |
| | | particle 8 | | | | | |
| Example 9 | Toner 9 | Toner | detected | yes | yes | yes | 1000 |
| | | particle 9 | | | | | |
| Example 10 | Toner 10 | Toner | detected | yes | yes | yes | 500 |
| | | particle 10 | | | | | |
| Example 11 | Toner 11 | Toner | detected | yes | yes | yes | 500 |
| | | particle 11 | | | | | |
| Example 12 | Toner 12 | Toner | detected | yes | yes | yes | 500 |
| | | particle 12 | | | | | |
| Example 13 | Toner 13 | Toner | detected | yes | yes | yes | 500 |
| | | particle 13 | | | | | |
| Example 14 | Toner 14 | Toner | detected | yes | yes | yes | 500 |
| | | particle 14 | | | | | |
| Example 15 | Toner 15 | Toner | detected | yes | yes | yes | 500 |
| | | particle 15 | | | | | |
| Comparative | Toner 16 | Toner | — | — | yes | yes | 500 |
| example 1 | | particle 16 | | | | | |
| Comparative | Toner 17 | Toner | detected | yes | — | yes | 0 |
| example 2 | | particle 17 | | | | | |
| Comparative | Toner 18 | Toner | detected | yes | yes | — | 500 |
| example 3 | | particle 14 | | | | | |

| | | Content | | | | Content | | |
|---|---|---|---|---|---|---|---|---|
| | Content | of | | | | of | | |
| | of | hydrotalcite | | | | External | Thickness | |
| | boron | particle | | | Presence of | additive | of | |
| | atom | [H]/part | | | External | A/part | polyester | External |
| | [B]/ | by | | | additive | by | resin/ | additive |
| | ppm | mass | H/B | D/H × 10⁻³ | A | mass | nm | B |
| Example 1 | 1.0 | 0.10 | 0.1 | 5.00 | yes | 3.0 | 530.0 | yes |
| Example 2 | 1.0 | 0.02 | 0.02 | 25.00 | yes | 8.0 | 700.0 | yes |
| Example 3 | 1.0 | 0.80 | 0.8 | 0.63 | yes | 0.5 | 300.0 | — |
| Example 4 | 1.0 | 0.10 | 0.1 | 0.20 | yes | 0.1 | <10 | — |
| Example 5 | 1.0 | 0.10 | 0.1 | 8.00 | yes | 10.0 | <10 | — |
| Example 6 | 1.0 | 0.05 | 0.0 | 0.20 | — | — | <10 | — |
| Example 7 | 1.0 | 0.10 | 0.1 | 10.00 | — | — | <10 | — |
| Example 8 | 2.0 | 0.10 | 0.05 | 10.00 | — | — | <10 | — |
| Example 9 | 10.0 | 0.10 | 0.01 | 10.00 | — | — | <10 | — |
| Example 10 | 2.0 | 2.00 | 1.000 | 0.25 | — | — | <10 | — |
| Example 11 | 10.0 | 0.02 | 0.0020 | 25.00 | — | — | <10 | — |
| Example 12 | 25.0 | 0.0 | 0.0004 | 50.00 | — | — | <10 | — |
| Example 13 | 0.5 | 3.00 | 6.0000 | 0.17 | — | — | <10 | — |
| Example 14 | 0.1 | 3.00 | 30.0000 | 0.17 | — | — | <10 | — |
| Example 15 | 100.0 | 0.01 | 0.0001 | 50.00 | — | — | <10 | — |
| Comparative | 0.0 | 3.00 | — | 0.17 | — | — | <10 | — |
| example 1 | | | | | | | | |
| Comparative | 0.1 | 3.00 | 30.0000 | — | — | — | <10 | — |
| example 2 | | | | | | | | |
| Comparative | 0.1 | 0.00 | 0.0000 | — | — | — | <10 | — |
| example 3 | | | | | | | | |

TABLE 2

| | | | | | | | | Difference in |
|---|---|---|---|---|---|---|---|---|
| | | | | | | | | amount of |
| | | Initial 1 dot reproduction | | 1 dot reproduction after LL endurance | | Fogging after LL endurance | | charge between |
| | Toner | Evaluation | Measurement | Evaluation | Measurement | Evaluation | Measurement | before and after |
| | No. | rank | value | rank | value | rank | value | endurance |
| Example 1 | Toner | A | 12.2 | A | 12.0 | A | 0.2 | 101% |
| | 1 | | | | | | | |
| Example 2 | Toner | A | 12.3 | A | 11.8 | A | 0.3 | 105% |
| | 2 | | | | | | | |
| Example 3 | Toner | A | 12.3 | A | 11.7 | A | 0.3 | 108% |
| | 3 | | | | | | | |
| Example 4 | Toner | A | 12.2 | A | 12.0 | B | 0.7 | 107% |
| | 4 | | | | | | | |
| Example 5 | Toner | A | 12.3 | A | 12.1 | B | 0.8 | 109% |
| | 5 | | | | | | | |
| Example 6 | Toner | A | 12.0 | B | 10.0 | C | 1.2 | 115% |
| | 6 | | | | | | | |
| Example 7 | Toner | A | 11.9 | B | 9.9 | C | 1.1 | 114% |
| | 7 | | | | | | | |
| Example 8 | Toner | A | 11.8 | B | 10.1 | C | 1.3 | 116% |
| | 8 | | | | | | | |
| Example 9 | Toner | A | 12.0 | B | 9.8 | C | 1.2 | 118% |
| | 9 | | | | | | | |
| Example 10 | Toner | A | 12.0 | B | 9.9 | C | 1.2 | 115% |
| | 10 | | | | | | | |
| Example 11 | Toner | A | 12.0 | B | 10.0 | C | 1.3 | 118% |
| | 11 | | | | | | | |
| Example 12 | Toner | C | 6.5 | C | 6.2 | C | 1.1 | 105% |
| | 12 | | | | | | | |
| Example 13 | Toner | B | 10.0 | C | 6.1 | C | 1.2 | 125% |
| | 13 | | | | | | | |
| Example 14 | Toner | A | 12.0 | C | 6.2 | C | 1.1 | 124% |
| | 14 | | | | | | | |
| Example 15 | Toner | A | 11.9 | C | 6.0 | C | 1.2 | 104% |
| | 15 | | | | | | | |
| Comparative | Toner | C | 6.4 | E | 3.1 | E | 2.8 | 135% |
| example 1 | 16 | | | | | | | |
| Comparative | Toner | C | 6.4 | E | 3.0 | E | 3.3 | 134% |
| example 2 | 17 | | | | | | | |
| Comparative | Toner | D | 5.1 | E | 3.2 | E | 2.1 | 90% |
| example 3 | 18 | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-209747, filed Dec. 27, 2022 and No. 2023-200924, filed Nov. 28, 2023, which are hereby incorporated by reference herein in their entirety.

What is claimed is:

1. A toner comprising:
a toner particle containing a binder resin; and
an external additive,
wherein a fragment peak derived from a boron atom and a fragment peak derived from a boron-oxygen structure are detected by time-of-flight secondary ion mass spectrometry (TOF-SIMS) measurement of the toner,
the toner particle contains dodecylbenzenesulfonic acid or a dodecylbenzenesulfonic acid salt, and
hydrotalcite is contained as the external additive.

2. The toner according to claim 1,
wherein abundance (mass basis) of boron atom is 0.1 ppm or more and 100 ppm or less when the toner is measured using an inductively coupled plasma mass spectrometer (ICP-MS).

3. The toner according to claim 1,
wherein a content (mass basis) of the dodecylbenzenesulfonic acid or the dodecylbenzenesulfonic acid salt is 10 ppm or more and 1,000 ppm or less relative to the toner.

4. The toner according to claim 1,
wherein a content of hydrotalcite in the toner is 0.01 parts by mass or more and 3.00 parts by mass or less relative to 100 parts by mass of toner particle.

5. The toner according to claim 1,
wherein the relationship between the abundance B (ppm) of boron atom and the content H (parts by mass) of hydrotalcite satisfies Formula (1),

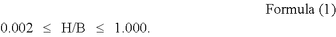

6. The toner according to claim 1,
wherein the relationship between the content D (ppm) of dodecylbenzenesulfonic acid or dodecylbenzenesulfonic acid salt and the content H (parts by mass) of hydrotalcite satisfies Formula (2),

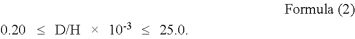

7. The toner according to claim 1,
wherein the toner particle has a polyester resin as a surface layer of the toner particle, and
the surface layer has a thickness of 300 nm or more and 700 nm or less.
